(19) United States
(12) Patent Application Publication
(10) Pub. No.: US 2024/0251819 A1
(43) Pub. Date: Aug. 1, 2024

(54) FORTIFIED CONFECTION COMPOSITIONS

(71) Applicant: GLANBIA NUTRITIONALS LIMITED, Kilkenny (IE)

(72) Inventors: Stephanie LEE, Twin Falls, ID (US); Stephen J. ADOLPHSON, Twin Falls, ID (US); Jason DEMMERLY, Twin Falls, ID (US); Loren WARD, Twin Falls, ID (US)

(73) Assignee: GLANBIA NUTRITIONALS LIMITED, Kilkenny (IE)

(21) Appl. No.: 18/424,215

(22) Filed: Jan. 26, 2024

Related U.S. Application Data
(60) Provisional application No. 63/441,708, filed on Jan. 27, 2023.

(51) Int. Cl. A23G 3/42; A23G 3/36; A23G 3/44

(52) U.S. Cl. CPC A23G 3/42; A23G 3/368; A23G 3/44

(57) ABSTRACT

Disclosed is a method for improving the stability of bioactive compounds in confection formats. The method involves the formulation of a confectionary application, such as a gummy or jellybean to utilize dietary fiber in place of standard reducing sugar carbohydrates such as corn syrup, sugar, dextrose, etc.

### PRIORITY OF INVENTION

This application claims priority to U.S. Provisional Application No. 63/441,708 that was filed on Jan. 27, 2023. The entire content of the application referenced above is hereby incorporated by reference herein.

### FIELD OF THE INVENTION

The invention relates to gummy and related confections and the formulation and ingredients involved in making those products. More specifically, the invention relates to the combination of particular ingredients that will yield improved stability of vitamins and bioactive compounds added to the confectionary products.

### BACKGROUND OF THE INVENTION

Vitamin fortification of gummies is becoming an increasingly popular vehicle to deliver vitamins and micronutrients. Many adults and children have difficulty swallowing pills and gummy vitamins can be a much more convenient way to boost vitamin intake, prevent disease and maintain good health. Gummies are the preferred delivery format for supplements, with over 27% of consumers preferring them over tablets, capsules, softgels, etc. According to Allied Market Research (Himanshu, V., & Roshan, D. (2020, March) Gummy vitamins market by type (single vitamin, multivitamin and prebiotics), demographics (children and adult), and sales channel (hypermarket and supermarket, specialty stores, retail pharmacies, and online sales channel): global opportunity analysis and industry forecast, 2019-2026. Allied Market Research. https://www.alliedmarketresearch.com/gummy-vitamins-market-A06064#:˜:text=The%20gummy%20vitamins%20market%20size,dominance%20throughout%20the%20forecast%20period), in 2018 the vitamin gummy market was valued at $5.7 billion and is projected to reach $9.3 billion by 2026. Typically, gummy vitamins are made with sugar, corn syrup, water, gelatin and/or pectin, the particular vitamin/nutrient premix along with minor ingredients such as flavor, color, food grade acidulant, etc. The leading nutrient in gummy supplements is Vitamin C, with over 54% of new vitamin gummies containing this vitamin. Other key nutrients in gummy supplements include: B group vitamins, followed by vitamins D, E and A, along with other more specialized nutrients.

Along with vitamin fortification, manufacturers are using the gummy format to deliver on other bioactive compounds such as amino acid derivatives like gamma-aminobutyric acid (GABA) and theanine, as well as other natural compounds like chamomile extract, lemon balm, lavender, etc. Commercial products of these gummies tend to be sugar based and use either gelatin or pectin or a combination of the two as the gelling agent.

As sugar has increasingly been linked to have negative health consequences, sugar replacers are becoming more common in gummy vitamins. Maltitol is a sugar alcohol that is commonly used in sugar free gummy applications due to the functionality it provides in the formulation. However, excessive consumption of sugar alcohols can lead to digestive issues of bloating, gas, and have a laxative effect. The addition of fiber is another way to reduce sugar in gummy applications. Chicory root fiber/inulin, polydextrose, and soluble corn or tapioca fibers are the most commonly seen fibers in commercialized gummy products. The level of fortification is generally 4-6 g of dietary fiber per serving depending on the serving size weight and number of gummies per serving. Almost all fiber gummies on the market have fiber as the sole fortified nutrient. One exception is the commercial product Vitafusion Fiber Well Fit gummies that combines polydextrose fiber with the addition of 6 B-vitamins. However, polydextrose can also have reducing sugars and promote degradation reactions (IFF. (n.d.). Litesse Polydextrose. https://www.dupontnutritionandbiosciences.com/product-range/dietary-fibers/litesse.html). Particularly under low pH and high heat (similar to what is done to manufacture gummies) polydextrose will break down and produce the reducing sugar glucose (Beer et al., (1991) Stability of polydextrose solutions to heat treatment and storage under acid conditions. Lebensmittel-Wissenschaft and Technologie 24(3); 245-251).

As most of the ingredients that go into the gummy product are commodity-based and relatively cheap, the vitamins and/or bioactive ingredients are the functional component of the fortified gummies, and therefore contribute significantly to the overall cost of manufacturing.

Manufacturers of fortified gummies are required by law to ensure that the micronutrients are not only evenly dispersed throughout the gummies, but that over the course of shelf life the consumer will still receive the effective dose of the micronutrient that is claimed on the label. As such, gummy manufacturers will add excess vitamins and nutrients so that as vitamin degradation occurs, the claimed level of micronutrient will still be reached. There are many different mechanisms for vitamin degradation including light, oxygen, heat, etc. Identifying ways to limit exposure to these factors can improve the stability of the micronutrient.

In full sugar gummy vitamins, there is abundant reducing sugars available for chemical reactions, such as the Maillard reaction. The Maillard reaction occurs when an amine group reacts with the reducing end of a carbohydrate. Even sucrose, which has no reducing end, is easily broken down into its components of glucose and fructose, particularly in the presence of heat. As such, it is also readily available to react with amine groups in the Maillard reaction.

Many bioactive and vitamin compounds are either amino acid derivatives, such as theanine, GABA, etc., or have free amine groups in their structure, such as folic acid, thiamine, glutamine, etc. This free, nucleophilic amine group on these structures is available to react with the carbonyl group on the reducing sugar which poses a potential for degradation of these vitamins and bioactive compounds. Doyon, L., & Smyrl, T. G. (1983) (Interaction of thiamine with reducing sugars. Food Chemistry 12, 127-133) studied the interaction of Thiamine with reducing sugars and found that thiamine loss increased by 37% when it was in the presence of a reducing sugar. They also found that the type of carbohydrate also affected the rate of degradation (maltose<glucose<xylose). However, this study was conducted in a simple aqueous solution, not in a finished application. They also made no mention of dietary fiber or how a non-reducing sugar might impact stability as the control was simply distilled water.

This nucleophilic reaction on the reducing sugar by the amine group is bound to happen in the presence of heat, moisture and time (Fennema, O., Damodaran, S., Parkin, K. 2008. Food Chemistry (4th Edition). CRC Press), all of which are present in the gummy manufacturing process. Fennema et al. (2008) also describe how the type of carbohydrate affects the reactivity with amine groups in that aldoses, such as glucose, galactose, etc. are more reactive than ketoses, such as fructose. They go on to say that sugars in their acyclic form are more reactive than those in the cyclic form. Without being bound to theory, the selection of a carbohydrate source with little to no reducing potential, such as those of dietary fibers, would allow for a reduction in the reaction between the amine group on the bioactive molecule and the reducing end of the carbohydrate. This reduction in reactivity would therefore improve the stability of the bioactive compound over time.

Because of this nutrient degradation that occurs over the course of a fortified confectionary product's shelf life, there is a need to discover ways to preserve the bioactivity of these compounds. Doing so has the potential to cut back on the amount of overage that a manufacturer would need to add, thereby reducing cost. It would also extend the shelf life of the product and reduce the amount of product waste going to landfills thereby also helping to minimize the impact to the environment. Finally, it would also make it easier for individuals to gain these necessary nutrients in their diet.

### SUMMARY OF THE INVENTION

The present disclosure provides a confectionary product that retains the integrity and shelf life of vitamins and bioactive compounds in the product through the formulation and selection of ingredients used to make the product. The examples presented utilize a gummy and starch-based (e.g., jellybean) formats, but the invention could similarly be applied to other confectionary products, such as but not limited to, chocolates, gum drops, etc.

In certain aspects, provided herein is a fortified confection composition comprising (a) a dietary fiber component with a low reducing potential, and (b) a bioactive amine-containing compound, and (c) optionally, a reducing carbohydrate, wherein the bioactive amine-containing compound in the fortified confection composition retains a significant amount of its initial bioactivity for up to one year. In certain embodiments, the fiber content replaces reducing carbohydrate up to and including one hundred percent. In certain embodiments, the fortified confection is devoid of reducing carbohydrates. Other components of the composition include a gelling agent, such as gelatin and/or pectin, and other minor components such as flavor, color, acidulant, etc.

### BRIEF DESCRIPTION OF THE DRAWINGS

FIG. 1. Effect of Inulin Dietary Fiber on L-Theanine Levels in Gummies Stored at Ambient Conditions.

FIG. 2. Effect of Inulin Dietary Fiber on L-Theanine Levels in Gummies Stored at Accelerated Storage Conditions.

FIG. 3. Effect of Inulin Dietary Fiber on GABA Levels in Gummies Stored at Ambient Conditions.

FIG. 4. Effect of Inulin Dietary Fiber on GABA Levels in Gummies Stored at Accelerated Storage Conditions.

FIG. 5. L-Theanine levels in Starch Jellies-Ambient. Upper line shows inulin raw Theanine starch jelly; lower line shows control raw Theanine starch jelly.

FIG. 6. L-Theanine levels in Starch Jellies-Accelerated. Upper line shows inulin raw Theanine starch jelly; lower line shows control raw Theanine starch jelly.

### BRIEF DESCRIPTION

### Fortified Confection Composition

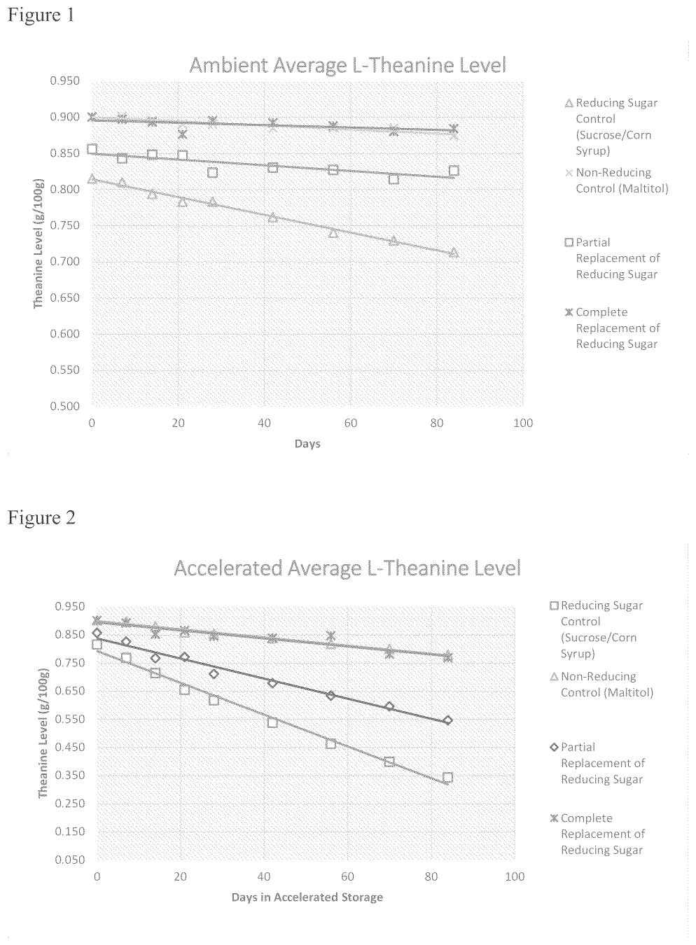

In certain aspects, provided herein is a fortified confection composition comprising (a) a dietary fiber component with low reducing potential, (b) a bioactive amine-containing component, and (c) optionally, a reducing carbohydrate, wherein the bioactive amine-containing compound in the fortified confection composition retains significantly higher levels of the bioactive amine-containing compound compared to the standard, reducing sugar control for up to one year when stored at a temperature of 20-30° C. See FIG. 1 for an example.

In certain aspects the bioactive amine-containing compound retains significantly higher bioactivity compared to compositions with a reducing sugar control formula when stored for up to 60 weeks when stored at a temperature of 30-40° C. For example, see FIG. 2.

The examples presented utilize gummy and starch-based confection (e.g., jellybean) formats, but the invention could similarly be applied to other confectionary products, such as but not limited to, chocolates, gum drops, etc.

In certain aspects, the fortified confection composition is formulated to reduce the interaction of an amine group in the bioactive amine-containing component and a reducing moiety of the carbohydrate.

In certain aspects, the non-reducing dietary fiber component has a low reducing potential resulting in a fortified confection composition with low levels of reducing sugar.

### Low Reducing Potential Dietary Fiber

In certain aspects, the low reducing potential dietary fiber component comprises inulin, chicory root fiber, soluble corn fiber, soluble tapioca fiber, or polydextrose or other low reducing potential fiber sources.

In certain aspects, the low reducing potential dietary fiber component comprises inulin or chicory root fiber.

In certain aspects, the low reducing potential dietary fiber component comprises soluble corn or soluble tapioca fiber.

In certain aspects, the low reducing potential dietary fiber component comprises polydextrose.

In certain aspects, the low reducing potential dietary fiber component comprises two or more dietary fibers.

In certain aspects, a combination of various low reducing potential dietary fibers may be used to produce desired textures in the finished confectionary application.

### Bioactive Amine-Containing Compound

In certain aspects, the bioactive amine-containing compound comprises at least one amine moiety.

In certain aspects, the bioactive amine-containing compound is a vitamin comprising at least one amine moiety.

In certain aspects, the bioactive amine-containing compound comprises theanine, gamma-aminobutyric acid (GABA), folic acid, thiamine, or amino acids such as glutamine.

In certain aspects, the bioactive amine-containing compound is GABA.

In certain aspects, the bioactive amine-containing compound is L-Theanine.

In certain aspects, the bioactive amine-containing component comprises two or more agents.

### Reducing Carbohydrate

In certain aspects, the reducing carbohydrate is a reducing sugar. In certain embodiments the reducing carbohydrate is present at a concentration of less than 75% of the original value but the preferred embodiment would be a 50-100% replacement of reducing sugars. In certain embodiments, the fortified confection is devoid of reducing carbohydrates.

### Exemplary Method of Making Product

In certain embodiments, the product is made by the steps of heating a mixture of pre-bloomed gelatin, pectin, and selected carbohydrates. After a set temperature is reached, the bioactive compound is added along with any acidulants, color and flavor. The mixture is then deposited into starch or silicone molds and allowed to set for approximately 24 hours. The selected carbohydrates mentioned may utilize certain fibers, such as inulin, soluble corn fiber, polydextrose, or other fibers to act as a bulking agent and also to minimize vitamin/bioactive loss over time. The method described may also utilize fiber in combination with reducing sugars to provide a partial protective effect on the stability of the vitamins/bioactive agents.

### Example 1

Effect of fiber on L-Theanine stability in a gummy format. Control gummies were made with both reducing sugars and non-reducing sugars using the formulas shown in Table 1.

TABLE 1
L-Theanine & Reducing Sugar Control Formula

| | Reducing Sugar | Non-Reducing |
|---|---|---|
| | Control | Sugar Control |
| Ingredient | % of Total Formula | % of Total Formula |
| Unipectine 569 Pectin | 0.44% | 0.44% |
| 250 Bloom Gelatin | 4.42% | 4.42% |
| Water for Gelatin | 9.16% | 9.16% |
| RAW Theanine | 0.59% | 0.59% |
| Water for Theanine Solution | 5.00% | 5.00% |
| 43/43 Corn Syrup | 29.30% | |
| Maltitol Syrup | | 29.30% |
| Sugar | 24.60% | |
| Granulated Maltitol | | 24.60% |
| Water for Pectin | 21.70% | 21.70% |
| Sugar for Pectin | 2.21% | |
| Granulated Maltitol for Pectin | | 2.21% |
| Citric Acid 50% solution | 2.48% | 2.48% |
| TOTAL | 100.00% | 100.00% |

Gummies with decreased levels or complete replacement of reducing sugar were made according to the formulas shown in Table 2.

TABLE 2
L-Theanine & Decreased Reducing Sugar Formulas

| | Partial | Complete |
|---|---|---|
| | Replacement of | Replacement of |
| | Reducing Sugar | Reducing Sugar |
| Ingredient | % of Total Formula | % of Total Formula |
| Unipectine 569 Pectin | 0.44% | 0.44% |
| 250 Bloom Gelatin | 4.42% | 4.42% |
| Water for Gelatin | 9.16% | 9.16% |
| RAW Theanine | 0.59% | 0.59% |
| Water for Theanine Solution | 5.00% | 5.00% |
| Inulin Syrup | 27.69% | 55.38% |
| Granulated Sugar | 27.69% | |
| Water for Pectin | 21.70% | 21.70% |
| Granular Inulin for Pectin | 2.21% | 2.21% |
| Citric Acid 50% solution | 1.00% | 1.00% |
| Carnauba Wax | 0.10% | 0.10% |
| TOTAL | 100.00% | 100.00% |

All batches were made according to the following procedure:
Gelatin is hydrated in water in a beaker at ambient conditions (˜70° F.) for 30 minutes, then placed in a 90° C. water bath for 45 minutes.
Pectin is dry blended with powdered carbohydrate, and slowly dispersed into water while heating (85-90° C.) and stirring.
Additional carbohydrate, both liquid and dry, is heated to 90° C. in a pot, after which the pectin mixture is added.
The pectin/carbohydrate mixture is cooked to 117° C. or 87° C. Brix, then cooled to 100° C. after which the gelatin mixture is added and mixed gently till fully dispersed.
A slurry of bioactive compound (Theanine) at a level to deliver 50 mg of Theanine per serving (1.04%) is made then added to the mixture and stirred thoroughly. A solution of citric acid is also added at this stage.
Target Brix is 79-80° C. Brix.
Mixture is deposited into prepared starch molds and allowed to set for 24 hours.

Samples were stored in both ambient and accelerated storage conditions. Accelerated storage conditions are 35° C., 55% humidity. Ambient and accelerated gummy samples were analyzed in triplicate via UPLC for Theanine content using the method outlined in the Waters Corporation AcQuity UPLC Amino Acid Analysis System Guide (Waters Corporation (2012) AcQuity UPLC H-Class and H-Class Bio Amino Acid Analysis System Guide) initially and also weekly for the first four weeks, then every other week for the next 8 weeks. Batches made with inulin fiber showed noticeably improved stability of the L-Theanine over time. Table 3 shows the levels of L-Theanine loss in samples stored in both ambient and accelerated conditions.

TABLE 3
% L-Theanine Loss

| | Ambient | Accelerated |
|---|---|---|
| Sample | % Loss | % Loss |
| Reducing Sugar Control | 12.5 | 58 |
| Non-Reducing Control | 3.0 | 13.7 |
| Partial Replacement of Reducing Sugar | 3.5 | 36.3 |
| Complete Replacement of Reducing Sugar | 1.8 | 14.8 |

The batch with a complete replacement of reducing sugar showed a marked improvement in the stability of L-Theanine, which mirrored that of the non-reducing control batch. A partial protective benefit is seen in a batch with a 50% replacement of reducing sugar for a low reducing potential dietary fiber, such as inulin.

### Example 2

This example looked at the effect of dietary fiber on the stability of GABA in a gummy format. Gummies with reducing sugar and non-reducing sugar controls as well as gummies made with complete replacement of reducing sugar were made using the formulas in Table 4 using the same basic procedure outlined in Example 1. The target GABA dosage was 50 mg in a 5 g serving.

TABLE 4
GABA & Reducing Sugar Control Formula

| | | | Complete |
|---|---|---|---|
| | Reducing | Non-Reducing | Replacement |
| | Sugar | Control | of Reducing |
| | Control | (Maltitol) | Sugar |
| | % Total | % Total | % Total |
| Ingredient | Formula | Formula | Formula |
| Unipectine 569 Pectin | 0.44% | 0.44% | 0.44% |
| 250 Bloom Gelatin | 4.42% | 4.42% | 4.42% |
| Water for Gelatin | 9.17% | 9.17% | 9.17% |
| GABA Powder | 0.72% | 0.72% | 0.72% |
| Water for GABA Solution | 5.52% | 5.52% | 4.00% |
| 43/43 Corn Syrup | 29.07% | | |
| Maltitol Syrup | | 29.07% | |
| Sugar | 24.26% | | |
| Inulin Syrup | | | 54.85% |
| Granular Maltitol | | 24.26% | |
| Water for Pectin | 21.71% | 21.71% | 21.71% |
| Sugar for Pectin | 2.21% | | |
| Granular Inulin for Pectin | | | 2.21% |
| Granular Maltitol for Pectin | | 2.21% | |
| Citric Acid 50% solution | 2.48% | 2.48% | 2.48% |
| TOTAL | 100.00% | 100.00% | 100.00% |

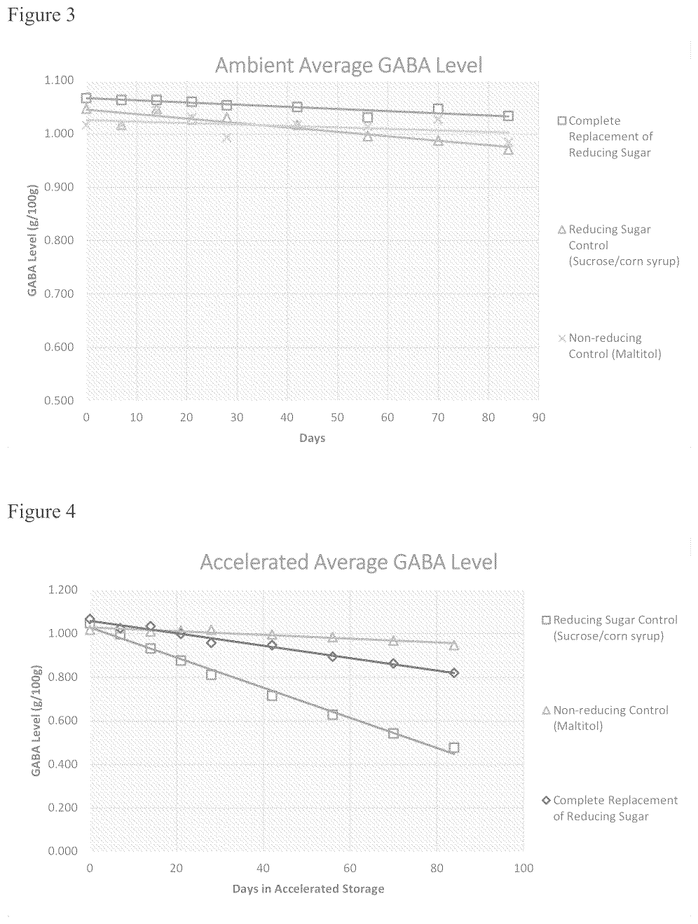

Samples were stored and analyzed in similar manner using the same method to that found in Example 1. Stability results are shown in FIG. 3 for ambient storage and FIG. 4 for accelerated storage. Stability of GABA is significantly improved through the use of dietary fiber compared to the reducing sugar control. Table 5 shows that the percent loss of GABA in a low reducing potential dietary fiber-based gummy is approximately half that compared to the reducing sugar control.

TABLE 5
% GABA Loss

| | Ambient | Accelerated |
|---|---|---|
| Sample | Storage % Loss | Storage % Loss |
| Reducing Sugar Control | 7.29 | 54.55 |
| Non-Reducing Control | 3.18 | 6.92 |
| Inulin Base | 3.13 | 23.28 |

### Example 3

The present methods can be used to make non-gummy confections, such as a jellybean, which does not utilize typical gelling agents (gelatin/pectin), but rather modified starches. Jellybeans (starch-based confections) were made with and without dietary fiber and the levels of bioactive amine compounds (L-Theanine) were looked at over time.

This example looked at the stability of L-Theanine in a starch-based confection, such as a jellybean, where the gelling agent is not gelatin or pectin. Jellybean confections were made with both reducing sugar control and also a complete replacement of reducing sugar with inulin according to the formulas shown in Table 6 below. The target theanine dosage was 50 mg per 5 g serving.

TABLE 6
L-Theanine and Reducing Sugar Control Formulas

| | Reducing Sugar | Complete Replacement of |
|---|---|---|
| | Control | Reducing Sugar |
| Ingredient | % Total Formula | % Total Formula |
| Corn Syrup | 23.38% | |
| Granulated Sugar | 20.14% | |
| Inulin Syrup | | 23.38% |
| Maltitol (granular) | | 20.14% |
| Water | 40.03% | 40.03% |
| Modified Corn Starch | 7.64% | 7.64% |
| Citric Acid 50% Solution | 1.47% | 1.47% |
| Flavor | 0.49% | 0.49% |
| Color | 0.22% | 0.22% |
| L-Theanine | 0.62% | 0.62% |
| Water for L-Theanine | 6.01% | 6.01% |

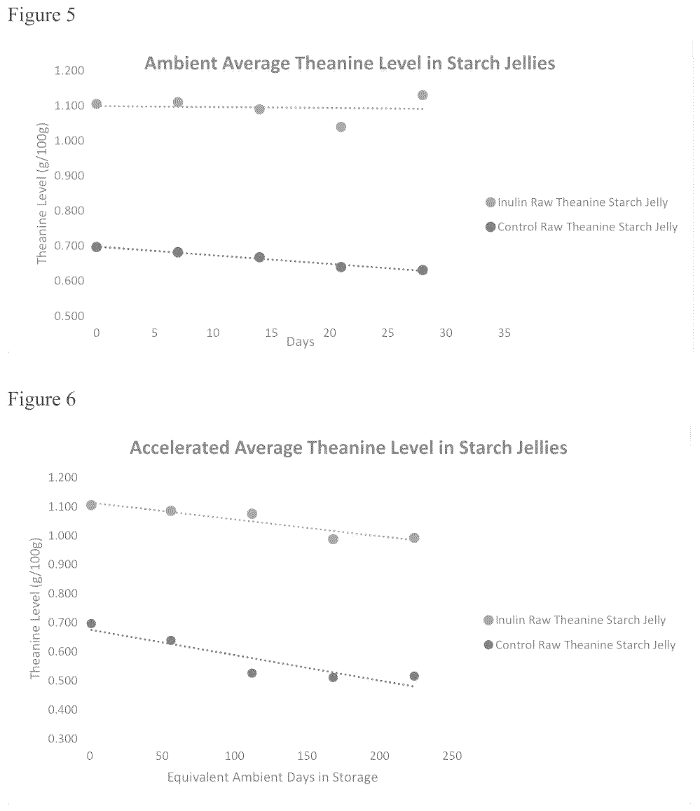

Samples were stored and analyzed in a similar manner using the same method to that found in Example 1. Stability results are shown in FIG. 5 for ambient storage and FIG. 6 for accelerated storage. Stability of L-Theanine is improved through the use of dietary fiber compared to the reducing sugar control. Table 7 shows the percent loss of L-Theanine in a low reducing potential dietary fiber-based confection.

TABLE 7
% L-Theanine Loss in Starch-Based Confection

| Sample | Ambient % Loss | Accelerated Storage % Loss |
|---|---|---|
| Reducing Sugar Control | 10.03 | 29.83 |
| Inulin Base | 0.76 | 12.06 |

Thus, similar to the gummies, the degradation levels were decreased, thus extending the shelf-life of the confection, and reducing the amount of overage needed by manufacturers.

Although the foregoing specification and examples fully disclose and enable the present invention, they are not intended to limit the scope of the invention, which is defined by the claims appended hereto.

All publications, patents and patent applications are incorporated herein by reference. While in the foregoing specification this invention has been described in relation to certain embodiments thereof, and many details have been set forth for purposes of illustration, it will be apparent to those skilled in the art that the invention is susceptible to additional embodiments and that certain of the details described herein may be varied considerably without departing from the basic principles of the invention.

The use of the terms “a” and “an” and “the” and similar referents in the context of describing the invention are to be construed to cover both the singular and the plural, unless otherwise indicated herein or clearly contradicted by context.

As used herein, the term “about,” when referring to a value is meant to encompass variations of, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. It is understood that embodiments described herein include “consisting of” and/or “consisting essentially of” embodiments.

The transitional phrase “consisting of” excludes any element, step, or ingredient not specified in the claim.

“Consisting essentially of” generally limits a feature, compound, composition or method to the recited elements and/or steps but does not exclude the possibility of additional elements and/or steps that do not materially affect the function, compound, composition and/or characteristics of the recited feature, compound, composition or method. The transitional phrase “consisting essentially of” limits the scope of a claim to the specified materials or steps and those that do not materially affect the basic and novel characteristic(s) of the claimed invention.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fortified confection composition comprising (a) a dietary fiber component with low reducing potential, (b) a bioactive amine-containing compound, and (c) optionally, a reducing carbohydrate, wherein the bioactive amine-containing compound in the fortified confection composition retains a significant amount of its initial bioactivity when compared to the control and stored at a temperature of 20° C. to 35° C.

2. The fortified confection composition of claim 1, wherein the low reducing potential dietary fiber component comprises inulin, chicory root fiber, soluble corn fiber, soluble tapioca fiber, or polydextrose.

3. The fortified confection composition of claim 1, wherein the low reducing potential dietary fiber component comprises inulin or chicory root fiber.

4. The fortified confection composition of claim 1, wherein the low reducing potential dietary fiber component comprises soluble corn or soluble tapioca fiber.

5. The fortified confection composition of claim 1, wherein the low reducing potential dietary fiber component comprises polydextrose.

6. The fortified confection composition of claim 1, wherein the low reducing potential dietary fiber component comprises two or more dietary fibers.

7. The fortified confection composition of claim 1, wherein the confection utilizes starch-based gelling agents.

8. The fortified confection composition of claim 1, wherein the bioactive amine-containing component comprises at least one bioactive amine-containing agent.

9. The fortified confection composition of claim 1, wherein the bioactive amine-containing agent comprises a vitamin comprising at least one amine group.

10. The fortified confection composition of claim 1, wherein the bioactive amine-containing agent comprises theanine, gamma-aminobutyric acid (GABA), folic acid, thiamine, or amino acids such as glutamine.

11. The fortified confection composition of claim 10, wherein the bioactive amine-containing agent is GABA.

12. The fortified confection composition of claim 10, wherein the bioactive amine-containing agent is L-Theanine.

13. The fortified confection composition of claim 10, wherein the bioactive amine-containing component comprises two or more agents.

14. The fortified confection composition of claim 1, wherein partial protection of the bioactive amine containing compound may be achieved through decreased levels of the reducing sugar component.

15. The fortified confection composition of claim 14, wherein the reducing sugar component may be decreased by various levels from 50 up to 100 percent.

16. The fortified confection composition of claim 1, wherein no reducing carbohydrate is present.

17. The fortified confection composition of claim 1, wherein the reducing carbohydrate is present at a concentration of less than 75% of the original value with a preferred embodiment of 50-100% replacement of reducing sugars 0-10% w/w.
